(19) United States
(12) Patent Application Publication
(10) Pub. No.: US 2002/0198819 A1
(43) Pub. Date: Dec. 26, 2002

(54) Method and apparatus for risk based pricing

(76) Inventors: Rodrigo Munoz, Fairfield, CA (US); Daniel Tom, Streamwood, IL (US)

Correspondence Address: BUCKLEY, MASCHOFF, TALWALKAR, & ALLISON, 5 ELM STREET, NEW CANAAN, CT, 06840, US

(21) Appl. No.: 09/886,434

(22) Filed: Jun. 21, 2001

(51) Int. Cl. G06F 17/60

(52) U.S. Cl. 705/38

(57) ABSTRACT

A system, method, apparatus, computer program code and means for pricing a financial product includes first receiving application data. A price for the financial product is selected. Based on the application data, expected loss data for the application is calculated. A potential return on investment (ROI) for the application is then calculated based at least in part on the expected loss data and the price. The application, with the selected price, is approved if the potential ROI is within a target ROI.

### CROSS-REFERENCE TO RELATED APPLICATIONS

This application is related to commonly-owned U.S. patent application Ser. No. ______, filed Jun. 21, 2001 (on even date herewith), Attorney Docket No. G03.011 for “METHOD AND APPARATUS FOR LOAN APPROVAL”, and U.S. patent application Ser. No. ______, filed Jun. 21, 2001 (on even date herewith), Attorney Docket No. G03.013 for “METHOD AND APPARATUS FOR MATCHING RISK TO RETURN”, the contents of each of which are incorporated by reference in their entirety for all purposes.

### FIELD OF THE INVENTION

The present invention relates to methods and apparatus for making decisions regarding the pricing of terms for financial products. More particularly, embodiments of the present invention relate to methods and apparatus for pricing terms of a financial product in conjunction with the evaluation of an application for a financial product.

### BACKGROUND OF THE INVENTION

Financial institutions offer a wide variety of different financial products to consumers and other entities (“applicants”). These products, such as loans or leases, are approved or disapproved based on information regarding a particular applicant and other information relating to the transaction. Typically, the application is for a particular financial product with a particular price (e.g., an automobile loan bearing interest at a particular annual percentage rate (APR)). Particularly with respect to financial products offered to consumer applicants, financial institutions traditionally make approval decisions based primarily on the applicant's credit risk. Typically, an application for a financial product is received and “scored” using one or more credit risk models. Typical credit risk models include proprietary models or fee-based models such as those offered by Equifax, Experian, or Trans Union (each of which generate so-called “FICO” scores based on a model developed by Fair, Isaac).

Use of these models, however, still requires that one or more individuals at the financial institution be given the final authority to approve a financial application. For example, an individual credit manager at a financial institution may be authorized to utilize his or her best judgment to make a final approval or disapproval of a consumer loan application after it has been scored using one or more credit risk models. That is, the credit manager uses his or her judgment to determine whether to, for example, lend money to an individual applicant with a given credit score. Unfortunately, this process can lead to inconsistent lending practices (e.g., one credit manager may approve a loan to an individual with a marginal FICO score, while another manager may deny a similarly-situated individual). Further, the process does not allow the financial institution to maximize or regulate its expected return on investment (ROI) because the product price is not varied.

Some consistency of application has been achieved through the use of tiered products. For example, a financial institution which provides leases for automobiles may establish several tiers of lease products, each having different criteria for eligibility, one of which is related to the applicant's credit score. This allows differential pricing of products based on historical performance within each product, and also eliminates some of the inconsistency of approvals which can result from blanket reliance on the discretion of credit managers.

However, there could be high risk deals within a tier, especially when the risk is near the tier cutoff. For certain types of financial products, there could also be collateral risk (e.g., where the collateral is an.automobile, a particular automobile may have a faster than average depreciation rate). By simply approving or disapproving applications based on credit risk and loss risk calculations, the return on investment for a particular application may not be maximized. Further, too many applications must be approved manually. This can be a drain on resources and can lead to inconsistent application of approval standards. The pricing of tiered products can also make it difficult to maximize a lender's ROI for the product, especially where the application falls near the border of the tier.

Commonly-assigned, and co-pending U.S. patent application Ser. No. ______ for “METHOD AND APPARATUS FOR LOAN APPROVAL” describes one technique for reducing the amount of manual approval required in the financial application approval process. The referenced invention accomplishes this, in part, by calculating a potential ROI for an application and comparing the potential ROI to an expected ROI. Applications which do not meet the expected ROI are rejected. The referenced invention relates to tiered products where prices have been pre-established by the financial institution offering the product. This type of pricing is appropriate where the number of potential scenarios is manageable. For example, a financial institution can establish several pricing tiers based on different risk levels that the financial institution is willing to experience for different applicants. However, this type of pricing may not always maximize a lender's return on investment, particularly where an applicant falls near the border of a particular pricing tier.

It would be desirable to provide a method and system which allows a financial institution to maximize its ROI on financial products by variably establishing a price for a product based on the risk presented by a particular application. Preferably, such pricing is accomplished without the need to establish pricing tiers for those products. Preferably, the method and system reduces the amount of manual approval required in the.financial application approval process. It would further be desirable to provide such a system which is automated and which allows remote interaction over public or private networks.

### SUMMARY OF THE INVENTION

To alleviate the problems inherent in the prior art, and to provide an improved decision making tool for approving or declining financial applications, embodiments of the present invention provide a system, method, apparatus, computer program code and means for evaluating an application for a financial product.

According to one embodiment, a system, apparatus, method, computer program code and means for pricing a financial product includes first receiving application data. A price for the financial product is selected. Based on the application data, expected cash flow data and loss data for the application is calculated. A potential return on investment (ROI) for the application is then calculated based at least in part on the expected cash flow data and loss data. The application, with the selected price, is approved if the potential ROI is within a target ROI.

In one embodiment, the price selected is an initial price which is known to be a low price. According to one embodiment, the process is repeated if the potential ROI resulting from the selected price is not within the target ROI. For example, if the potential ROI is below the target ROI, the price may be increased and the steps of calculating expected cash flow and loss data and calculating a potential ROI may be repeated until the potential ROI is within the target ROI. Alternatively, if the potential ROI is above the target ROI, the price may be decreased to provide a more attractive price to the applicant, so long as the resulting potential price is still within the target ROI.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a flow diagram depicting a process for evaluating an application for a financial product according to one embodiment of the present invention;

FIG. 2 is a block diagram of a system consistent with the present invention;

FIG. 3 is a block diagram of a lender device of the system of FIG. 2 pursuant to an embodiment of the present invention;

FIG. 4 is a table depicting an exemplary applicant database used in the system of FIG. 2;

FIG. 5 is a table depicting exemplary loss estimate data used in the system of FIG. 2; and

FIG. 6 is a flow diagram depicting a process for evaluating an application for a financial product according to a further embodiment of the present invention.

### DETAILED DESCRIPTION OF THE INVENTION

Applicants of the present invention have recognized that there is a need to improve lender flexibility and accuracy in pricing financial products. In particular, Applicants have recognized that there is a need to allow lenders to establish and enforce expected returns on investment (ROI) for particular financial products. Applicants have discovered that a system and method which allows a lender to establish a price and adjust that price for each application until an expected ROI is achieved will allow lenders to establish and enforce ROI objectives.

For the purposes of describing embodiments of the present invention, a number of terms will be used herein. As used herein, the term “financial institution” will be used to refer to a bank, credit union, or other lender or entity which extends credit to or otherwise underwrites financial products to applicants. As used herein, the term “lender” may be used interchangeably with the term “financial institution”. As used herein, the term “applicant” is used to refer to an individual or entity which is applying for approval of a financial product offered by a financial institution. As used herein, the term “financial product” is used to refer to a loan, lease, or other item of credit extended by a financial institution to an applicant. As used herein, the term “price” is used to refer to a fee or other cost of funds of a financial product which will be received by the financial institution if an application is approved. Example “prices” include the annual percentage rate (APR) received by a financial institution for a loan, or basis points received by a financial institution for a lease product. The “price” may also include the monthly payments for a loan or lease product. Other types of “prices” are known to those skilled in the art.

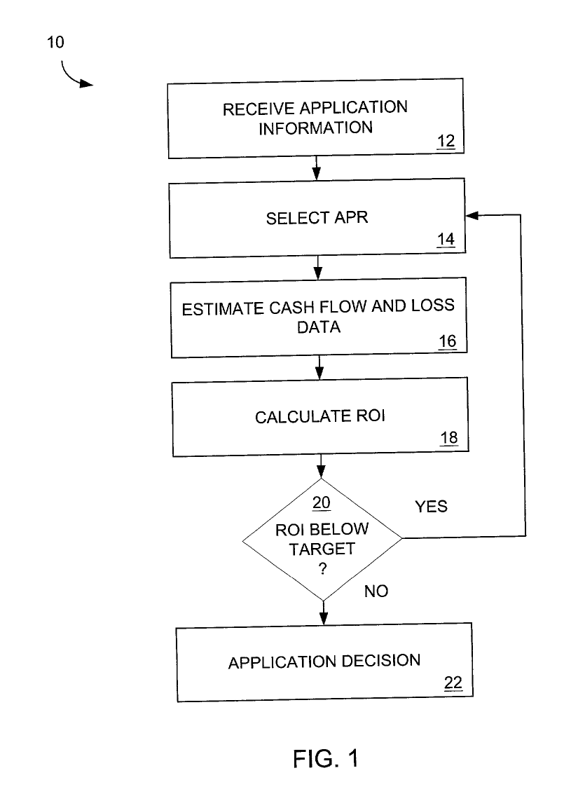

Referring now to FIG. 1, a process 10 is shown according to one embodiment of the present invention. Process 10 may be conducted by, or on behalf of, a financial institution to allow the financial institution to make application pricing and approval decisions according to embodiments of the present invention. In particular, process 10 provides a method by which the financial institution can establish and utilize target return on investment (ROI) factors in the approval process and to establish a price for a financial product.

Process 10 begins at 12 where application information is received. This application information may be received directly from an applicant for a financial product such as a loan or a lease, or it may be received from an intermediary, such as a loan officer at a car dealership. The nature and extent of the application information received may vary depending on the particular needs of the financial institution and also depending on the nature of the financial product for which approval is sought. In general, application information received at 12 may include information identifying the application, information identifying collateral to be pledged in security of the financial product, and information regarding the financial aspects of the application.

For example, where the financial product is a car lease, the application information received may include: the applicant's social security number and contact information, a vehicle identification number (VIN) of the vehicle being leased, mileage information regarding the vehicle being leased, the amount of the requested lease, etc. Other information relating to the applicant's credit may also be received at this time, such as a credit rating of the applicant. This credit rating and other credit information may be received from a third party, such as a commercial credit rating service such as services offered by Experian or other companies. In one embodiment, the credit rating may be represented, for example, by a so-called “FICO” credit score. In other embodiments, the credit information may be generated after receipt of the application information. Those skilled in the art will recognize that any of a number of rating systems may be used, and that a combination of one or more systems may also be used to generate credit information used with embodiments of the present invention.

Once this application information has been received, processing continues at 14 where the system of the present invention operates to select an initial price of the requested financial product. A number of different initial prices may be used. For example, where the financial product is a loan, the initial price selected may be an annual percentage rate (APR) of zero or some amount less than the then-current market rates for loan products.

Once an initial price has been selected, processing continues at 16 where the system of the present invention operates to calculate cash flow and loss data for the particular applicant, for the particular financial product requested, at the initial price selected at 14. The expected cash flow can be calculated by estimating the costs associated with the product (e.g., origination expenses, collection costs, etc.) and expected income associated with the product (e.g., monthly payments, payoff amounts, etc.) for each month of the product for each of several termination scenarios for the product (these termination scenarios will be discussed further below). The loss data may be estimated by determining the probabilities of a number of different termination events occurring during the life of the financial product (e.g., early payoff of a lease, etc.) based on the initial price. The expected cash flow and loss data calculated at 16 are used to estimate a potential ROI for the particular application at the price selected at 14. Typically, the price required to achieve a reasonable ROI for a particular product increases with the risk of a particular applicant. A high risk applicant will require a higher priced product (e.g., a loan with a higher APR) to achieve a desired ROI.

Processing continues at 18 where a return on investment (ROI) for the application based on the selected initial price for requested financial product is calculated. In particular, the ROI is based on the expected net income (NI) and the annualized net investment (ANI) is calculated, taking into account the expected cash flow and loss data calculated at 16. Once this ROI for the application at the initial price is calculated, processing continues to 20 where a determination is made whether the calculated ROI is within a target range for the ROI. This target range may be established by the financial institution and updated on a periodic basis to reflect the financial institution's desired ROI for particular products. A financial institution's target ROI may be established in any of a number of ways. In one embodiment, the target ROI is based on historical portfolio performance. In other embodiments, the target ROI is established using techniques described in commonly-assigned and co-pending U.S. patent application Ser. No. ______, filed Jun. 21, 2001 (on even date herewith), Attorney Docket No. G03.013 for “METHOD AND APPARATUS FOR MATCHING RISK TO RETURN”.

For example, the financial institution may establish target ranges for ROI for leases and loan. These target ranges may be established such that any application which falls within the target is automatically approved. Alternatively, or in addition, target ranges may be established where some manual intervention for approval may be required.

If processing at 20 indicates that an application based on the initial price is not within the target, processing reverts to 14 where a further price is selected. In one embodiment, a binary search approach to determining the appropriate price is used. Using this embodiment, the first price selected at 14 is selected as the mean of a range, where the lower bound of the range is a price of zero, and the higher bound of the range is a price equal to the total amount of the application (e.g., if the financial product is a loan for $20,000, the upper bound will be $20,000, and the initial price to test will be $10,000). If processing at 20 indicates that the calculated ROI for this initial price is below the target ROI (which it likely will), processing at 14 will select a next price which is the mean of of the range between the lower bound and the last selected price (in the example, the lower bound will remain $0, the upper bound will become $10,000, and the mean will become $5,000). This process will repeat until the system of the invention focuses in on a price which satisfies the target ROI.

Once this new price has been established, processing continues through steps 16-20 as described above. At 20, again, a determination is made whether the application based on the new price will provide a calculated ROI within the financial institution's established target for ROI. If the updated price still does not realize a calculated ROI which satisfies the target, processing again reverts to 14 where the process is again repeated. This repetitive search for a price which satisfies the financial institution's target for ROI may continue for a number of iterations until an appropriate price is found or until the application is ultimately rejected.

When processing at 20 indicates that the calculated ROI is within the target ROI, processing continues to 22 where an application decision is made. A financial institution may establish rules where an application may be automatically approved if a price can be found which satisfies the institution's target ROI. In some embodiments, the financial institution may establish rules which requires further inquiry into an application if the application is not within a certain automatic threshold. Other rules and procedures may be established, as will now be apparent to those skilled in the art, to allow efficient approval of applications. Further details and alternatives of each of these process steps will be described further below.

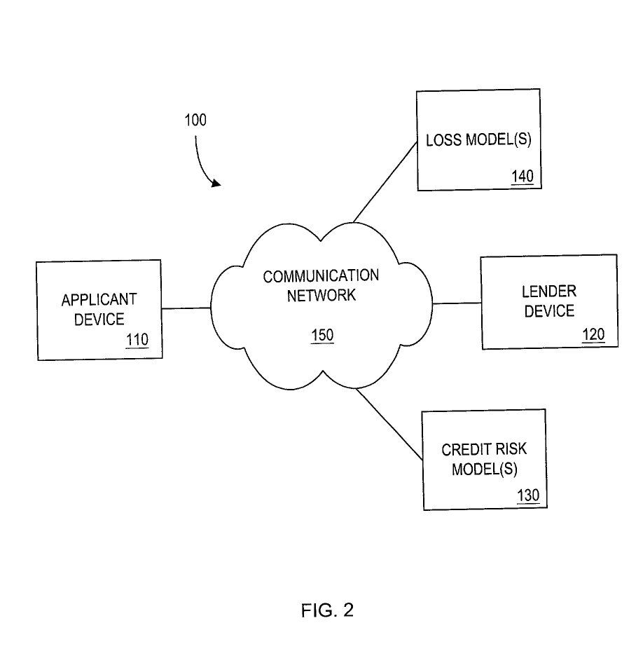

Referring now to FIG. 2, a system 100 pursuant to one embodiment of the present invention is shown. System 100 includes at least one applicant device 110 in communication with at least one vendor device 120. Vendor device 120 is in communication with one or more credit risk and loss model(s) 130,140.

As used herein, devices (such as applicant device 110 and lender device 120) may communicate, for example, via a communication network 150, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology. Security measures, known to those skilled in the art, may be used with embodiments of the present invention to ensure data security and privacy as data is moved between devices and stored at devices such as devices 110 and 120.

In one embodiment of the present invention, each applicant device 110 communicates with one or more remote, World Wide Web (“Web”)-based lender devices 120 (e.g., configured as a Web-server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Applicant device 110 and lender device 120 may be any devices capable of performing the various functions described herein. For example, either of applicant device 110 and lender device 120 may be, for example: a Personal Computer (PC), a portable computing device such as a Personal Digital Assistant (PDA), or any other appropriate computing, storage and/or communication device.

Note that although a single applicant device 110 and a single lender device 120 are shown in FIG. 2, any number of applicant and/or lender devices 110,120 may be included in system 100. In one currently preferred embodiment, system 100 will include a plurality of applicant devices 110 in communication with one or more lender devices 120. Similarly, any number of the other devices described herein may be included in 100 according to embodiments of the present invention.

Note that the devices shown in FIG. 2 need not be in constant communication. For example, applicant device 110 may only communicate with lender device 120 via the Internet when appropriate (e.g., when an applicant for a financial product of a lender desires to submit an application for approval pursuant to the present invention).

Further note that applicant device 110 need not be operated by the individual applicant applying for a financial product. Instead, applicant device 110 may be operated on behalf of the individual applicant by, for example, a lender agent or another entity. Similarly, lender device 120 need not be operated by the financial institution offering the financial product for which an application is received; instead, lender device 120 may be operated on behalf of the lender by a service provider or other agent of the financial institution.

Credit risk and loss model(s) 130, 140 may be data stores or may be devices operated by third party service providers. Model(s) 130, 140 may also be model(s) established by and operated by or on behalf of the lender operating lender device 120. A number of different model(s) may be used in conjunction with embodiments of the present invention. These models, as will be described more fully below, are used in embodiments of the present invention to first identify a particular product tier for a given application, and then to generate an estimate of an expected loss for the application.

Any of a number of different types (and combinations) of models may be used. For example, a credit risk model 130 such as the models offered by Experian may be used to generate a FICO score for a particular applicant. These credit risk models typically generate an assessment of an applicant's future risk of non-payment. Other proprietary and fee-based systems may also be used in conjunction with embodiments of the present invention. Data from one or more credit risk models 130 are used to identify an applicant's eligibility for one or more financial products as will be described further below.

One or more loss models 140 may also be used in conjunction with embodiments of the present invention. Those skilled in the art will recognize that a number of different proprietary and commercial systems have been developed for different types of financial products. In an embodiment used in conjunction with automobile financial products, such as vehicle leases or loans, account-level loss forecast models may be used which factor in the risk of one or more major termination events occurring. For example, for vehicle leasing, four early termination events may be considered: repossession, early payoff, insurance loss, and early turn-in (or, “quasi-repossession). One or more loss models 140 estimating the risk of occurrence of these events may be used in an embodiment of the present invention used to assist in the approval of vehicle lease applications. Other examples will be described further below.

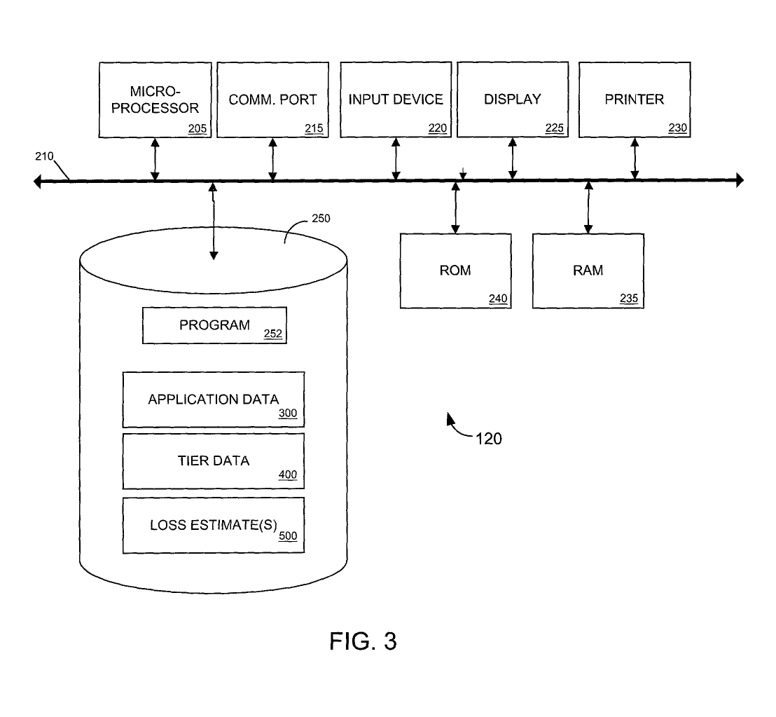

Details of one embodiment of lender device 120 will now be described by referring to FIG. 3 which is a block diagram of the internal architecture of an illustrative lender device 120. As illustrated, lender device 120 includes a microprocessor 205 in communication with a communication bus 210. Microprocessor 205 may be a Pentium, RISC-based, or other type of processor and is used to execute processor-executable process steps so as to control the elements of lender device 120 to provide desired functionality.

Also in communication with communication bus 210 is a communication port 215. Communication port 215 is used to transmit data to and to receive data from external devices, such as applicant device 110, and/or model(s) 130. Communication port 215 is therefore preferably configured with hardware suitable to physically interface with desired external devices and/or network connections. In one embodiment, applications for financial products are received from applicant device 110 via the Internet through communication port 215.

An input device 220, a display 225 and a printer 230 are also in communication with communication bus 220. Any known input device may be used as input device 220, including a keyboard, mouse, touch pad, voice-recognition system, or any combination of these devices.

Display 225, which may be an integral or separate CRT display, flat-panel display or the like, is used to output graphics and text to a user in response to commands issued by microprocessor 205. Such graphics and text may comprise a user interface as described herein. Printer 230 is an optional output device that produces a hardcopy of data using inkjet, thermal, dot-matrix, laser, or other printing technologies. Printer 230 may be used to produce a hardcopy of application data or other data produced by or used with embodiments of the invention.

A random access memory (RAM) 235 is connected to communication bus 210 to provide microprocessor 205 with fast data storage and retrieval. In this regard, processor-executable process steps being executed by microprocessor 205 are typically stored temporarily in RAM 235 and executed there from by microprocessor 205. A read-only memory device (ROM) 240, in contrast, may be provided to permit storage from which data can be retrieved but to which data cannot be stored. Accordingly, ROM 240 is used to store invariant process steps and other data, such as basic input/output instructions and data used during system boot-up or to control communication port 215.

A data storage device 250 stores processor-executable process steps comprising a program 252. Microprocessor 205 executes processor-executable process steps of program 252 in order to perform the functions set forth herein.

The data stored in data storage device 250 may be in a compressed, uncompiled and/or encrypted format. Furthermore, stored in data storage device 250 may be program elements that may be necessary for operation of server 200, such as an operating system and “device drivers” for allowing microprocessor 205 to interface with devices in communication with communication port 215. These program elements are known to those skilled in the art, and need not be described in detail herein.

Data storage device 250 also stores an applicant database 300 and loss estimate(s) data 400. The databases and data stores are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

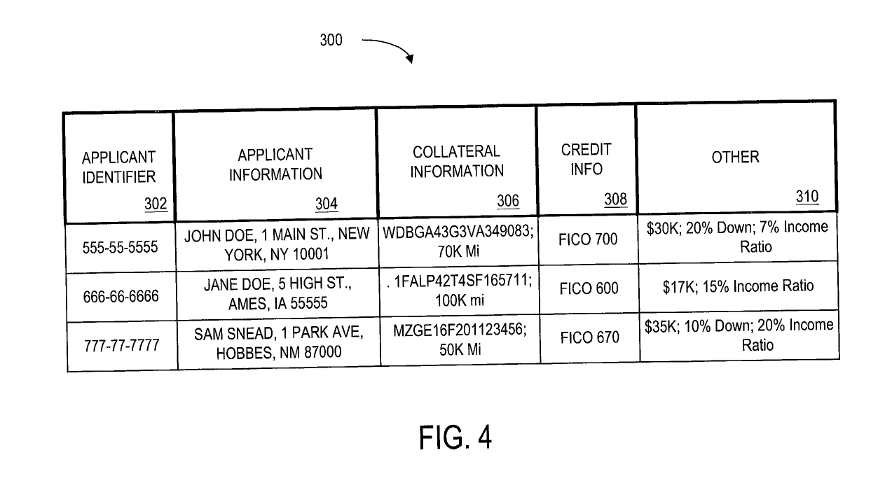

Referring now to FIG. 4, a table is shown representing application database 300 that may be stored at or accessible to lender device 120 according to an embodiment of the present invention. The table includes entries identifying particular applications which have been received for approval using techniques of the present invention. The table also defines a number of fields 302-310 for each of the entries. The fields specify: an applicant identifier 302, applicant information 304, collateral information 306, credit information 308, and other information 310. The information in database 300 may be created and updated, for example, based on information received from individual applicant devices 110. The information in database 300 may also be based on, for example, application information received via mail, telephone or other communication mediums and then entered into database 300.

Applicant identifier 302 may be, for example, an alphanumeric code associated with a particular applicant who has submitted an application for approval via system 100. In one currently-preferred embodiment, applicant identifier 302 is an individual's social security number or an entity's federal tax identification number.

Applicant information 304 may include information identifying the applicant such as, for example, the applicant's name and address and other contact information.

Collateral information 306 may include information particularly identifying one or more items of collateral which are intended to secure a financial product if the application is approved. For example, where the collateral is a vehicle such as an automobile, the collateral information may include a vehicle identification number (VIN) and mileage information for the particular automobile. Other information may also be provided to further identify the item (or items) of collateral.

Credit information 308 includes information identifying, for example, a credit score or other information indicating the credit worthiness of the applicant identified by applicant identifier 302. This information may be provided by credit risk model(s) 130. A number of proprietary and fee-based credit scoring models are known in the art and may be used to provide credit information 308.

Other information 310 may include other data used to identify the particular application to be approved or disapproved using techniques of the invention. For example, the amount of money to be financed, an amount of a down payment (if any), information identifying the applicant's payment to income ratio, information identifying the applicant's total debt ratio, or the like may be provided in field 310. Those skilled in the art will recognize that a number of other types of information may also be provided in database 300 to assist system 100 in making an approval decision. Further, the example datasets shown in FIG. 3 (as well as the other figures to be discussed) relate to automobile financial products. Those skilled in the art will recognize that other types of financial products may also benefit from techniques of the present invention.

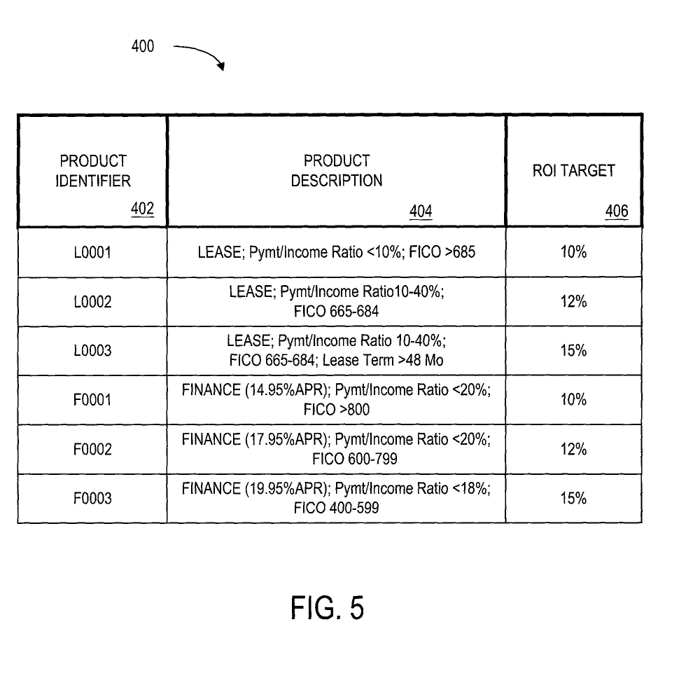

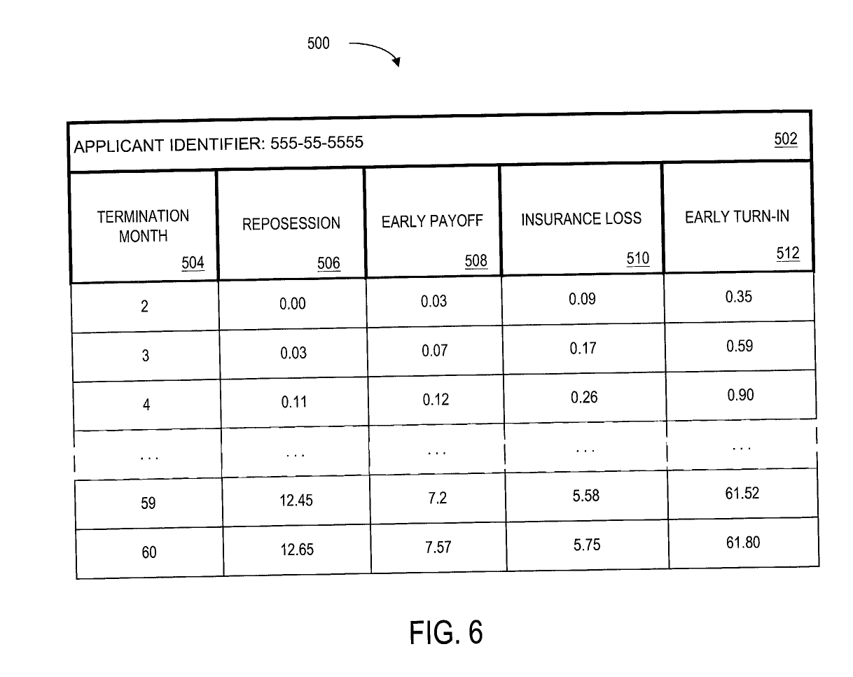

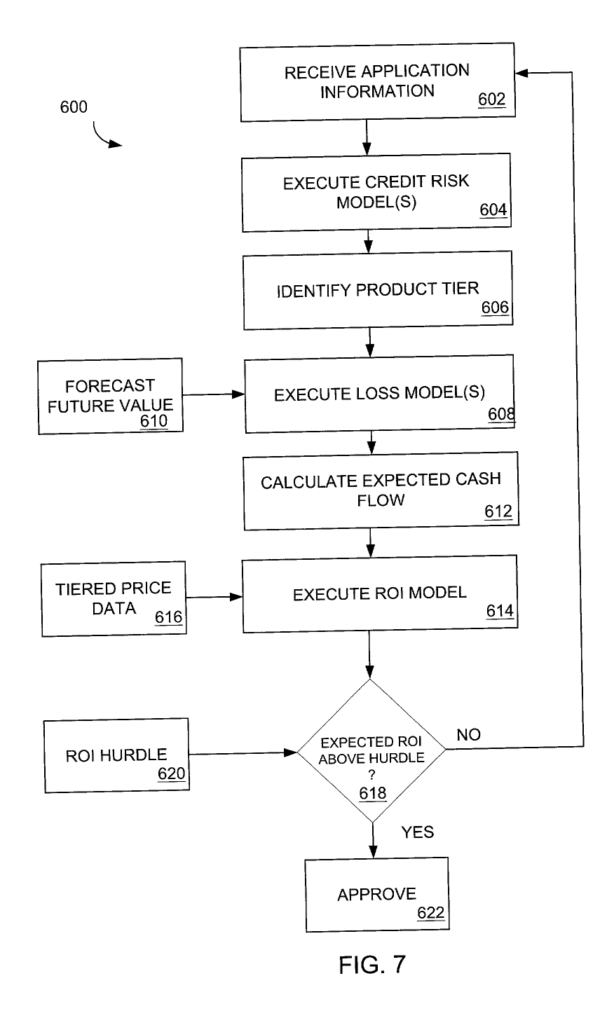

Referring now to FIG. 5, a table is shown representing probability of loss data 400 that may be generated by lender device 120 according to an embodiment of the present invention. The table includes data entries calculated using input from loss model(s) 140 to estimate the probability of losses occurring as a result of early termination of a product for which an application has been received. The table includes a number of fields 402-412 for each of the entries. The table of FIG. 5 is an example of a table generated for an application for an automobile lease. The fields included in the example include an applicant identifier 402 (preferably the same as or relating to the applicant identifier 302 of FIG. 4), a termination month 404 (representing each month of a lease product; the example is for a 60-month lease), and several termination scenarios 406-412 (repossession, early payoff, insurance loss, and early turn-in or “quasi-repossession”). The values in each of the fields 406-412 are estimates generated using one or more loss model(s) 140, and will be described more fully below in conjunction with a description of the process of FIG. 6.

The data represented by the table of FIG. 5 are presented here for illustrative purposes only. Those skilled in the art will recognize that other types and formats of data may also be used, depending on the type of financial product for which approval is sought. Further, this data is used in an intermediate calculation step and need not be permanently stored in system 100. Once the data represented by the table of FIG. 5 has been generated, further calculations are performed to generate an expected ROI for the application. This data is also used in conjunction with the calculation of expected cash flow data. For each month of the product, for each of the termination scenarios depicted in FIG. 5, expected monthly cash flow figures are calculated which take into account expenses and income associated with a termination event occurring in a given month. For example, a repossession occurring in month 2 will include expenses (cost of repossession) and later income (resale of the collateral some months later). These expected cash flow numbers may be generated using extrinsic data such as collateral depreciation schedules, etc.

Similar tables (not shown) may be generated to present loss data for an automobile loan. In such an example, different termination events may be calculated, including, for example: repossession, non-collateralized loss and early pay-off. Models known to those skilled in the art may be used to estimate loss probabilities for each month of the loan.

Referring now to FIG. 6, a process 600 is shown. Process 600 is one embodiment of a process for approving financial applications according to one embodiment of the present invention. Process 600 may be performed under the direction of program 252 of lender device 120 (as shown in FIG. 3, for example). In some embodiments, portions of process 600 may be performed by different devices to achieve the result of an approval decision. To facilitate understanding of features of the present invention, an example will be described in conjunction with a description of FIG. 6. In the example, an applicant is an individual consumer requesting approval of an automobile loan.

Processing begins at 602 where application information is received. This application information may include the information stored at application database 300 (FIG. 4) and may be received from applicant device 110. Information received at 602 includes information necessary to identify the applicant, the financial product requested, and collateral information (if any). For example, the individual consumer applying for an automobile lease may submit (or have an agent submit) application information including: the consumer's name and address, the consumer's social security number or federal tax identifier, information identifying the automobile (including the VIN and mileage information), and other information identifying the nature of the lease (e.g., 20% down, 7% income ratio, etc.). This information may be stored in application database 300.

Processing continues at 604 where a price is selected. According to embodiments of the present invention, a price of the financial product can be adjusted for each application to establish a price which realizes a ROI which satisfies the financial institution's target for ROI for particular types of products. This adjustment of the price begins at 604 where an initial price is selected. The initial price is preferably selected below a then-current market price for the financial product. For example, if the financial product is a loan for a used automobile, and the market rate for such loans is 9.0%, the initial price may be set below 9.0% (e.g., at 5% or even lower).

Processing continues at 606 where one or more credit risk models are executed based on the received application information. For example, in the automobile loan illustration, a credit risk model (such as credit risk model 130 of FIG. 2) may be executed to determine a risk of repossession of the vehicle (e.g., based on applicant's default of the loan terms). This credit risk model may result in the generation of a credit risk score (such as a FICO score or other score) which is stored in application database 300. Applicants have found that further calibrating the credit risk model by using the actual frequency of repossession over the first 24 months of automobile loans (or leases) has been useful to achieve greater accuracy in the forecasting of portfolio losses.

Once one or more credit risk models have been executed at 606, processing continues to 608 where one or more loss model(s) are executed (such as loss model(s) 140 of FIG. 2). The nature of the model(s) executed at this step will depend on the nature of the financial product for which an application has been received. For example, an application for an automobile loan will likely require the execution of a different model than an application for an automobile lease. Processing at 608 is performed to estimate, over the life of a financial product, the likelihood that the lender will suffer a loss prior to the natural termination of the product. A number of different loss models have been developed for various types of financial products. For example, losses may be modeled based on the use of historical data for similar applicants and similar products. Statistical models may utilize other data, such as actuarial data, to estimate losses for particular types of products.

Data such as a future value of a vehicle (generated in step 610) may also be provided to loss models at 608. In an embodiment used in conjunction with automobile leasing or financing, Applicants have found that estimation of the future value of a vehicle used as collateral for a lease or loan may be performed using any of a number of known techniques. For example, the technique referred to as “Winter's Multiplicative Seasonal Time Series” forecasting method may be used. As another example, a technique calculating an exponential decay between the vehicle's manufacturer suggested retail price (MSRP) and the residual value at the end of term may be used as well. Those skilled in the art will recognize that other techniques may also be used to facilitate the forecasting of potential losses.

An example will be provided by referring to FIG. 5, where a table shows a set of probabilities of loss for a particular applicant 402 who has applied for approval for a loan product. Because automobile loans are generally considered as having three early termination scenarios, table 400 shows loss estimates for each of the four scenarios (repossession, non-collateralized loss, and early payoff). These loss estimates are provided for each month during the term of the loan product (here, over 60 months). Given the risk, the term, and whether the collateral vehicle is new or used, loss models may be used to generate an estimated probability for each termination scenario for a given application. For example, if the loan term is 60 months, the model generates 60 different loss probabilities for each of the three termination events. Together with full term (no loss), there are 181 scenarios for this example. Applicants have found that, as compared to payment volatility, these premature termination events can be easier to model. Only the distinct month-event scenarios need be considered in many cases, versus the Monte Carlo methods which may be used to simulate payment volatility. Nevertheless, any of a number of different loss estimation techniques may be used.

According to one embodiment, each of the loss estimates are calculated using the system referred to as “Cox Regression” analysis. Where historical and/or actuarial data is available and useful, this may be used to augment the Cox Regression analysis. As can be seen in the example of FIG. 5, repossessions (especially later in the life of the product) are a big portion of potential losses that a lender may face.

A similar table of expected loss probabilities might be generated for an application for an automobile lease, except that the early termination scenarios for a lease are slightly different than the early termination scenarios for a loan. Early termination scenarios for a loan may include: repossession, early payoff, insurance loss, and early turn-in. Those skilled in the art will recognize that lenders utilize a number of loss models to estimate the probability of loss for each of these scenarios. These and other models may be used to estimate a likelihood of loss for other financial products such as loans.

Once loss model(s) have been executed at 608 (and loss probability data such as the example data of FIG. 5 have been generated), processing continues to 612 where expected cash flow for the application is calculated. This expected cash flow is calculated for each scenario generated by the loss model(s) at 608. Using collateral information and other data from the application (stored, e.g., in application database 300), the net income in a given month is calculated, taking into account the price established at 604. The Winter's Model referred to above may be used to estimate the future market value in a given month.

Processing continues at 614 where a calculated return on investment (ROI) is calculated. The ROI model then calculates the net income (NI) and annualized net investment (ANI) for each of the termination events as well as the full term event. The calculated ROI is calculated by taking the ratio of the expected NI to the expected ANI.

This calculated ROI is compared to an established ROI target received at 620 to determine if the calculated ROI which will be realized for a given application is within the ROI target for that particular product. If the calculated ROI is within the ROI target, the application is approved at 622. According to one embodiment of the present invention, this application approval decision may be communicated to the applicant or an agent of applicant via communication network 150 (FIG. 2).

According to the invention, the first comparison at 618 will typically indicate that the calculated ROI is below the ROI target (because, as described above, the initial price established at 604 may be selected as the mean between an upper and lower bound). A comparison at 618 which indicates that the calculated ROI is above the ROI target reverts the process back to 604 where a new price is selected. This price is adjusted from the previous price by using the binary search method described above. Once the price has been adjusted, steps 606-618 are repeated until a price which satisfies the ROI target is found. When a price which results in a calculated ROI within the ROI target is found, processing continues to 622 where the application is approved.

If repeated processing indicates that no price will satisfy the ROI target, the application is declined. Processing may revert to 602 where the application is resubmitted. In some embodiments, room for a manual decision to approve may be built-in to the process by allowing a manual decision to be made for applications which fail to meet the ROI target, but which are within a predetermined range (e.g., within 10% of the target), or based on other factors (e.g., based on information regarding the lender's volume targets, etc.).

In some embodiments, processing at 618 will indicate that the calculated ROI exceeds the ROI target. In some situations, processing may revert to 604 where the price is reduced to provide a more appealing price to the applicant while still attempting to satisfy the financial institution's ROI targets. The selected price may not necessarily fall within the target ROI for the product, in which case the lender may choose to either relax the target ROI or disapprove the application. In either event, such surveys will allow the lender to have a more clear understanding of the competitive marketplace so that it may more appropriately respond to applicants.

Although the present invention has been described with respect to a preferred embodiment thereof, those skilled in the art will note that various substitutions may be made to those embodiments described herein without departing from the spirit and scope of the present invention.

What is claimed is:

1. A method of pricing a financial product, the method comprising:
receiving application data;
selecting a price for said financial product;
calculating, based at least in part on said application data, expected cash flow data;
calculating, based at least in part on said expected cash flow data and said price, a potential return on investment (ROI) for said application; and
approving said application with said price if said potential ROI is within a target ROI.

2. The method of claim 1, wherein said application data includes at least one of: applicant information, collateral information, and payment information.

3. The method of claim 1, further comprising:
repeating said selecting a price, calculating expected cash flow data, and calculating a potential ROI if said potential ROI is not within said target ROI.

4. The method of claim 3, wherein said selecting a price further comprises increasing said price by an increment.

5. The method of claim 3, wherein said price is an annual percentage rate (APR) and wherein said increment is 0.25.

6. The method of claim 3, wherein said selecting a price further comprises decreasing said price by an increment.

7. The method of claim 1, wherein said price is an initial price, and wherein said price is an annual percentage rate (APR), and said initial price is selected below a current market APR.

8. The method of claim 1, further comprising calculating expected loss data, wherein said calculating comprises:
executing an account level loss forecast model;
executing a termination event model; and
calculating an expected loss in response to the execution of the account level loss forecast model and the execution of the termination event model.

9. The method of claim 8, wherein said executing an account level loss forecast model further comprises:
calculating a future value for an item of collateral associated with said application.

10. The method of claim 8, wherein said calculating expected loss data further comprises:
executing a risk model to compute a credit risk; and
generating probabilities of one or more termination events occurring before expiration of said financial product to form one or more termination scenarios.

11. The method of claim 10, wherein said calculating a potential ROI further comprises:
forecasting, based at least on said price, the severity of loss of said termination scenarios to form one or more loss scenarios;
calculating net income and annualized net investment for said loss scenarios; and
determining a potential ROI based on a ratio comprising said net income and said annualized net investment.

12. The method of claim 10, wherein said generating probabilities further comprises:
generating probabilities of said termination events occurring in relation to a plurality of payment times.

13. The method of claim 11, wherein said forecasting the severity of loss further comprises:
forecasting the severity of loss of said termination scenarios for at least a plurality of payment times.

14. The method of claim 10, wherein said financial product requires an item of collateral and wherein said forecasting comprises:
forecasting a current balance on book; forecasting a market value of said collateral; and
calculating a difference between said current balance on book and said market value of said collateral.

15. The method of claim 14, wherein said forecasting a market value is performed using at least one of: Winter's multiplicative time series estimation; or an exponential decay between a manufacturer suggested retail price of said collateral and a residual value of said collateral at the expiration.

16. The method of claim 10, wherein said financial product is a lease.

17. The method of claim 16, wherein said termination events comprise at least one of: repossession with delinquencies, early payoff, insurance loss, and repossession without delinquencies.

18. The method of claim 10, wherein said financial product is a loan.

19. The method of claim 18, wherein said termination events comprise at least one of: repossession, non-collateralized loss and early payoff.

20. A computer-readable medium bearing a computer program containing instruction steps such that upon installation of said computer program in a general purpose computer, the computer is capable of performing the method of claim 1.

21. A method of pricing a financial product, the method comprising:
receiving application data;
selecting an initial price for said financial product;
calculating, based at least in part on said application data, expected loss data;
calculating, based at least in part on said expected loss data and said initial price, a potential return on investment (ROI) for said application;
selecting a revised price for said financial product if said potential ROI based on said initial price is outside a target ROI;
calculating, based at least in part on said expected loss data and said revised price, a revised potential ROI for said application; and
approving said application if said revised potential ROI for said application is within a target ROI.

22. An apparatus for pricing a financial product, the apparatus comprising:
a processor;
a communication device, coupled to said processor, receiving application data from at least a first user device; and
a storage device in communication with said processor and storing instructions adapted to be executed by said processor to:
select a price for said financial product; calculate, based at least in part on said application data, expected loss data;
calculate, based at least in part on said expected loss data and said price, a potential return on investment (ROI) for said application; and
approve said application with said price if said potential ROI is within a target ROI.

23. The apparatus of claim 22, wherein said storage device further storing instructions adapted to be executed by said processor to:
select an updated price for said financial product if said potential ROI is not within a target ROI based on said initial price;
calculate an updated potential ROI for said application; and
approve said application with said updated price if said updated potential ROI is within said target ROI.

24. A system for pricing a financial product, comprising:
at least a first user device having a processor;
a communication device, coupled to said processor, configured to send and receive data over a network; and
a storage device in communication with said processor and storing instructions adapted to be executed by said processor to
receive application data; and
forward said application data to an at least first lender device said at least first lender device having
a second processor,
a second communication device, coupled to said second processor, configured to send and receive data over said network and to receive said application data; and
a second storage device in communication with said second processor and storing instructions adapted to be executed by said second processor to
select a price for said financial product;
calculate, based at least in part on said application data, expected loss data;
calculate, based at least in part on said expected loss data and said price, a potential return on investment (ROI) for said application; and
approve said application with said price if said potential ROI is within a target ROI.

25. The system of claim 24, wherein said second storage device further storing instructions adapted to be executed by said second processor to forward application approval data to said at least first device.

26. A computer program product in a computer readable medium for pricing a financial product, comprising:
first instructions for receiving application data;
second instructions for selecting an initial price for said financial product;
third instructions for calculating, based at least in part on said application data, expected loss data;
fourth instructions for calculating, based at least in part on said expected loss data and said initial price, a potential return on investment (ROI) for said application;
fifth instructions for selecting a revised price for said financial product if said potential ROI based on said initial price is outside a target ROI;
sixth instructions for calculating, based at least in part on said expected loss data and said revised price, a revised potential ROI for said application; and seventh instructions for approving said application if said revised potential ROI for said application is within a target ROI.

27. A device for pricing a financial product, the device comprising:
means for receiving application data;
means for selecting a price for said financial product;
means for calculating, based at least in part on said application data, expected loss data;
means for calculating, based at least in part on said expected loss data and said price, a potential return on investment (ROI) for said application; and means for approving said application with said price if said potential ROI is within a target ROI.
